(19) United States
(12) Patent Application Publication
(10) Pub. No.: US 2011/0069291 A1
(43) Pub. Date: Mar. 24, 2011

(54) PHYSICAL SENSOR FOR AUTOFOCUS SYSTEM

(76) Inventor: Michael R. Sogard, Menlo Park, CA (US)

(21) Appl. No.: 12/879,113

(22) Filed: Sep. 10, 2010

Related U.S. Application Data
(60) Provisional application No. 61/241,493, filed on Sep. 11, 2009.

(51) Int. Cl. G01B 13/02; G03B 27/52

(52) U.S. Cl. 355/55; 73/37.5

(57) ABSTRACT

Methods and apparatus for compensating for forces applied by a system which measures a height of a photoresist-coated surface of a wafer are disclosed. According to one aspect, a method for measuring a height associated with a wafer includes utilizing a measurement of an air flow through an air gauge or air bearing to estimate the height, determining a first magnitude of a bearing load exerted on the wafer from the air flow measurement, and compensating for the bearing load. The bearing load is exerted by an arrangement configured to determine the height associated with the wafer a first direction. Compensating for the bearing load includes applying an opposing force to the wafer that includes at least a vacuum preload force. The vacuum preload force is applied in a second direction that is opposite from the first direction. The opposing force is calculated to have a second magnitude that is approximately equal to the first magnitude.

### CROSS-REFERENCE TO RELATED APPLICATION

The present invention claims priority of U.S. Provisional Patent Application No. 61/241,493, filed Sep. 11, 2009, which is incorporated herein by reference in its entirety.

### BACKGROUND OF THE INVENTION

1. Field of the Invention

The present invention relates generally to equipment used in photolithography systems. More particularly, the present invention relates to a system which efficiently measures the height of a wafer surface.

2. Description of the Related Art

In many photolithography systems, the accuracy with which various measurements are made is crucial. For example, when the height of a photoresist-coated wafer surface is not accurately measured, then processes which depend on the height measurement may be compromised. Additionally, a wafer may be exposed to an image transmitted from a mask through a projection lens while not in the focal plane of the projection lens, which may lead to blurred exposure on the wafer.

Optical measurement systems may be used to measure heights of photoresist-coated wafer surfaces. An optical measurement system, e.g., an autofocus system, that measures a height of a wafer surface may utilize a vibrating mirror to deflect light beams at glancing angles over the wafer surface. The deflected light beams are sensitive to patterns on the wafer surface, as well as to thin film effects, e.g., Goos-Hanchen effects.

Thin film effects typically have an adverse effect on the measurement of heights of wafer surfaces. Unless there is some compensation for the thin film effects, the measurement of heights using optical technology is generally subject to inaccuracies. Significant measurement errors may occur. As there are effectively no practical solutions for Goos-Hanchen effects, the use of optical technologies to measure heights of photoresist-coated surfaces may be undesirable.

### SUMMARY OF THE INVENTION

The present invention pertains to a measurement system which utilizes an air gauge arrangement and a vacuum preload to effectively measure the height of a photoresist-coated surface of a wafer.

According to one aspect of the present invention, a method for measuring a height associated with a wafer includes utilizing a measurement of an air flow through an air gauge or air bearing to estimate the height, determining a first magnitude of a bearing load exerted on the wafer from the air flow measurement, and compensating for the bearing load. The bearing load is exerted in a first direction. Compensating for the bearing load includes applying an opposing force to the wafer that includes at least a vacuum preload force. The vacuum preload force is applied in a second direction that is opposite from the first direction. The opposing force is calculated to have a second magnitude that is approximately equal to the first magnitude.

In one embodiment, the opposing force includes an electromagnetic force that is also applied in the second direction. In such an embodiment, the opposing force includes the electromagnetic force when the height is not approximately equal to a nominal height.

According to another aspect of the present invention, an apparatus includes a stage arrangement, an air bearing arrangement, and a vacuum supply arrangement. The stage arrangement supports a wafer which has a first height. The air bearing arrangement includes an air gauge configured to measure the first height, and provides a bearing pressure signal. The air bearing arrangement exerts a bearing force, which has a first magnitude, in a first direction. The vacuum supply arrangement applies a vacuum preload force that opposes the bearing force. The vacuum preload force is applied on a second region of the wafer that is substantially adjacent to the first region of the wafer. The vacuum preload force is dynamically adjusted based on the bearing pressure signal.

Other aspects of the present invention will become apparent from the following detailed description taken in conjunction with the accompanying drawings which illustrate, by way of example, the principles of some embodiments of the present invention.

### BRIEF DESCRIPTION OF THE DRAWINGS

The invention will be readily understood by the following detailed description in conjunction with the accompanying drawings, in which:

FIG. 1 is a diagrammatic representation of a system in which an air gauge is configured to function as a relatively low stiffness air bearing and in which forces applied by the air gauge may be dynamically cancelled in accordance with an embodiment of the present invention.

FIG. 2 is a process flow diagram which illustrates a process of operating a system which utilizes an air gauge arrangement to measure the height of a photoresist-coated wafer surface, and a vacuum preload to compensate for forces applied by the air gauge arrangement, in accordance with an embodiment of the present invention.

FIG. 3 is a block diagram representation of an overall system which utilizes an air gauge arrangement and a vacuum preload arrangement, as well as a controller, to efficiently measure the height of a photoresist-coated wafer surface in accordance with an embodiment of the present invention.

FIG. 4 is a block diagram representation of an overall system which utilizes an air gauge arrangement, a vacuum preload arrangement, and electromagnetic forces to efficiently measure the height of a photoresist-coated wafer surface in accordance with an embodiment of the present invention.

FIG. 5 is a process flow diagram which illustrates a process of operating a system which utilizes an air gauge to measure the height of a photoresist-coated wafer surface, and both a vacuum preload force and an electromagnetic force to compensate for forces applied by the air gauge arrangement, in accordance with an embodiment of the present invention.

FIG. 6A is a diagrammatic representation of an air bearing arrangement with a vacuum preload from a side view in accordance with an embodiment of the present invention.

FIG. 6B is a diagrammatic representation of an air bearing arrangement with a vacuum preload from a bottom perspective in accordance with an embodiment of the present invention.

FIG. 7A is a diagrammatic representation of an air bearing arrangement with a vacuum preload and an electromagnet arrangement in accordance with an embodiment of the present invention.

FIG. 7B is a diagrammatic representation of an air bearing arrangement with a vacuum preload and an electromagnet arrangement, e.g., air bearing arrangement 704 of FIG. 7A, as shown with a control system in accordance with an embodiment of the present invention.

FIG. 8 is a diagrammatic bottom-view representation of an air bearing arrangement which includes electromagnets in accordance with an embodiment of the present invention.

FIG. 9 is a diagrammatic representation of a photolithography apparatus in accordance with an embodiment of the present invention.

FIG. 10 is a process flow diagram which illustrates the steps associated with fabricating a semiconductor device in accordance with an embodiment of the present invention.

FIG. 11 is a process flow diagram which illustrates the steps associated with processing a wafer, i.e., step 1004 of FIG. 10, in accordance with an embodiment of the present invention.

### DETAILED DESCRIPTION OF THE INVENTION

Example embodiments of the present invention are discussed below with reference to the various figures. However, those skilled in the art will readily appreciate that the detailed description given herein with respect to these figures is for explanatory purposes, as the invention extends beyond these embodiments.

Optical methods used to measure the height of a photoresist-coated wafer surface are typically sensitive to patterns on the wafer, and to thin film effects. Thus, optical methods may be subject to error and, hence, undesirable.

In one embodiment, a non-optical method that utilizes an air gauge and a vacuum preload accurately measures the height of a photoresist-coated wafer surface, substantially without sensitivity to patterns on the wafer and susceptibility to thin film effects. An air gauge arrangement may be used to measure the height of a photoresist-coated wafer surface when in proximity to the wafer surface. Such an air gauge arrangement and a wafer may be configured to function as a relatively low stiffness air bearing, and may therefore have a relatively large sensitivity to the height of a photoresist-coated wafer surface. An air bearing supplies a flow of air or other gas between two proximate surfaces, thereby maintaining a desired separation between the surfaces, despite external forces which would operate to substantially bring the surfaces together in the absence of the flow. The stiffness of the bearing is defined, in one embodiment, as the amount of external force required to change the separation by a specified amount. A low stiffness air bearing may utilize a relatively small amount of additional external force to reduce the separation by the specified amount.

Because an air gauge arrangement or, more specifically, the flow of air associated with the air gauge arrangement, applies a load or force to a wafer, dynamic compensation may be provided to substantially counteract the load. The dynamic compensation may take on a variety of different forms including, but not limited to include, applying a vacuum preload to the air gauge arrangement and/or utilizing an electromagnetic arrangement to provide attractive forces. It should be appreciated that the vacuum preload is typically applied in an opposite direction from the load applied by the air gauge arrangement, i.e., the bearing load or force, such that compensation for the bearing load may be substantially provided.

As mentioned above, the flow of air associated with the air gauge arrangement applies a load or force to a wafer. This force is compensated for because the wafer is mounted to a mechanical structure which has a finite stiffness. A vertical force imposed on the structure will, in general, cause a vertical displacement of the wafer which degrades the accuracy of the wafer height measurement. The vertical force may also degrade the positioning accuracy of the mechanical assembly to which the wafer is attached, such as a wafer stage. For example, a mechanical structure with a stiffness of approximately 100 N/micron is typically considered to be a fairly stiff structure. Nevertheless, a force of approximately 1 N may create a displacement of approximately 10 nm, which may be a potentially significant error. If the wafer is mounted to a fine stage whose vertical height is maintained by a control system, limitations of frequency response and the stage mass may limit the effective stiffness of the stage to approximately 10 N/micron or less. In this case, the force induced height error may be approximately 100 nm or more.

An air gauge arrangement, in addition to a vacuum preload arrangement and/or an electromagnetic arrangement, may generally be provided as a part of an autofocus system of a photolithography system. It should be understood, however, that the air gauge arrangement, vacuum preload arrangement, and electromagnetic arrangement are not limited to being included in an autofocus system, and may be incorporated into any suitable system or apparatus. Examples of autofocus systems are described, for example, in U.S. Pat. No. 5,191,200 and U.S. Pat. No. 5,602,399, which are each incorporated herein by reference in their entireties.

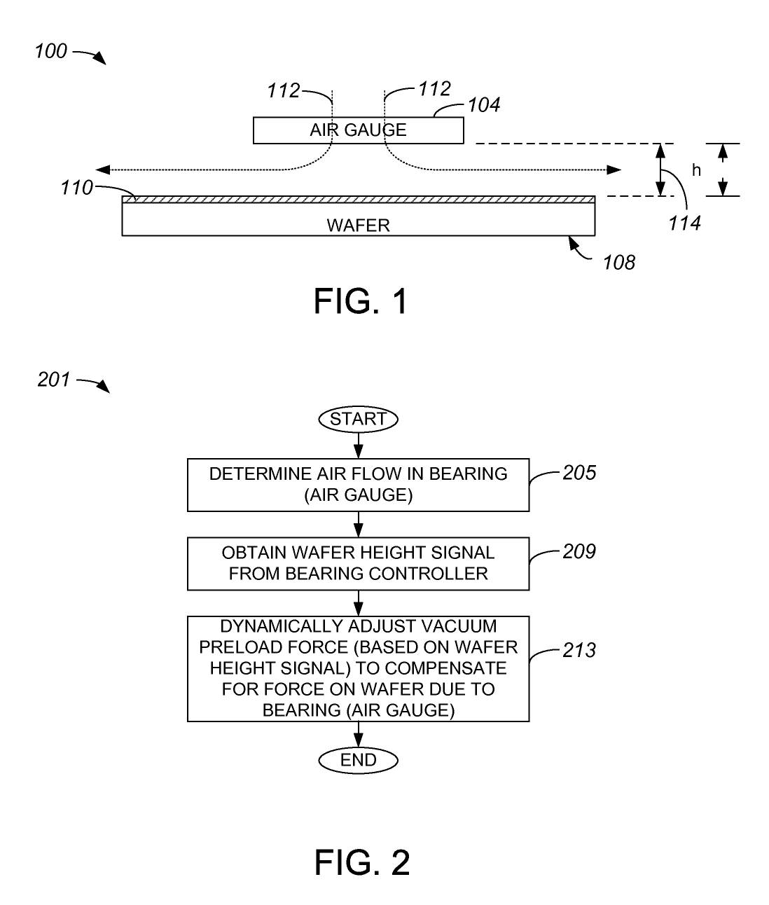

Referring initially to FIG. 1, a system in which an air gauge is configured to function as a relatively low stiffness air bearing and in which forces applied by the air gauge may be dynamically cancelled will be described in accordance with an embodiment of the present invention. A system 100 includes a wafer 108 and an air gauge 104 which are separated by a gap 114 with a height ‘h’. Wafer 108 may generally be held by a wafer stage arrangement (not shown) such that wafer 108 remains beneath air gauge 104.

Air gauge 104 is arranged to allow air 112 to flow therethrough, and is arranged to effectively measure the height of a photoresist-coated top surface 110 of wafer 108. Air gauge 104 is designed to function as an air bearing with a relatively large wafer height sensitivity. Thus, air gauge 104 is sensitive to changes in the height of photoresist-coated top surface 110 of wafer 108. Although any suitable air gauge 104 may be used to identify changes in the height of photoresist-coated top surface 110 of wafer 108, one suitable air gauge 104 may include a hot wire mass flow sensor which uses a sensor bridge to measure air flow within air gauge 104, and thereby determine height ‘h’ from a model or previous calibration.

As gap 114 and, hence, height ‘h’ varies, the flow of air 112 through air gauge 104 and over wafer 108 varies. Further, as air flow changes, pressure in air gauge 104 changes. Increasing air flow, i.e., increasing the flow rate of air 112, increases the pressure or force exerted by air 112 on photoresist-coated top surface 110 of wafer 108. By measuring the flow of air 112 on wafer 108, changes in height ‘h’ may be determined. Changes in the force exerted by the air gauge on the wafer may be inferred from the air flow changes.

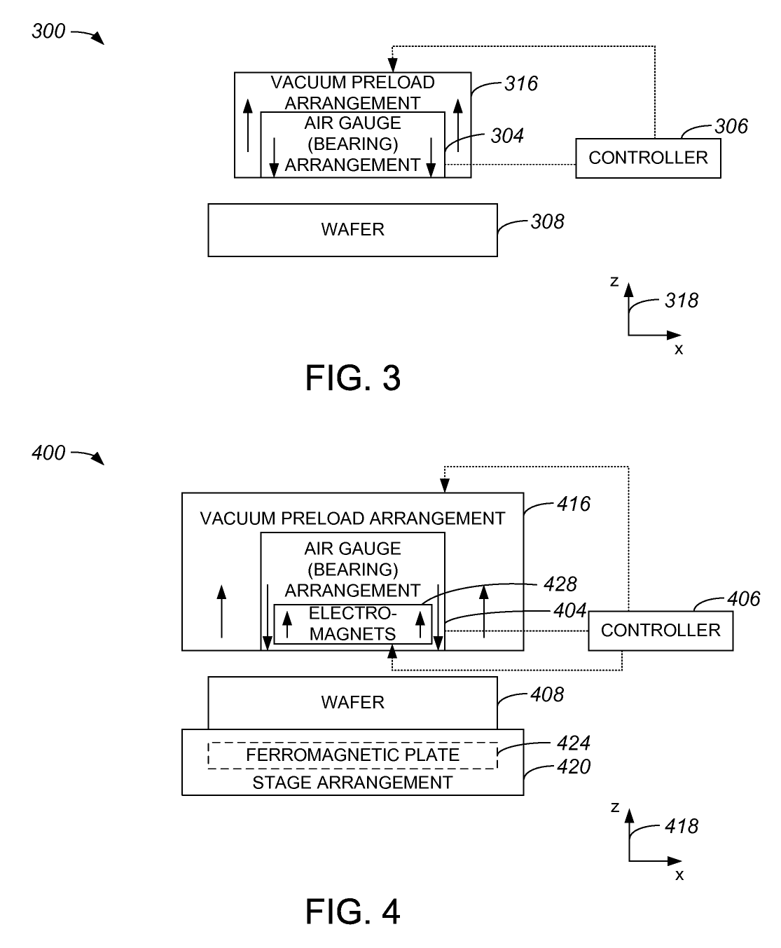

FIG. 2 is a process flow diagram which illustrates a process of operating a height measurement system which utilizes an air gauge arrangement to measure the height of a photoresist-coated wafer surface, and a vacuum preload to compensate for forces applied by the air gauge arrangement, in accordance with an embodiment of the present invention. A process 201 of operating a height measurement system begins at step 205 in which the air flow in an air bearing, e.g., an air gauge which substantially functions as a relatively low stiffness air bearing with a relatively high sensitivity to wafer height, is determined. The force on the wafer that is due to the air bearing is effectively inferred from, or otherwise calculated using, the measured air flow, either from a model or by calibration.

Once the air flow through the air gauge is determined, a wafer height signal is obtained from an air bearing controller in step 209. The wafer height signal is used in step 213 to dynamically adjust the vacuum preload force in order to compensate for the force on the wafer provided by the air bearing. As such, at least some degree of bearing force cancellation may be achieved in the presence of fluctuations in the height of a photoresist-coated wafer surface. In one embodiment, a vacuum preload force may be applied at a magnitude, and in a direction, that substantially opposes the bearing force applied on the wafer stage. That is, the vacuum preload force may be adjusted such that the vacuum preload force is substantially equal to and applied in a direction that counteracts the bearing force. Once the vacuum preload force is dynamically adjusted as appropriate to compensate for a bearing force, a final wafer height is established and the process of operating a height measurement system is completed.

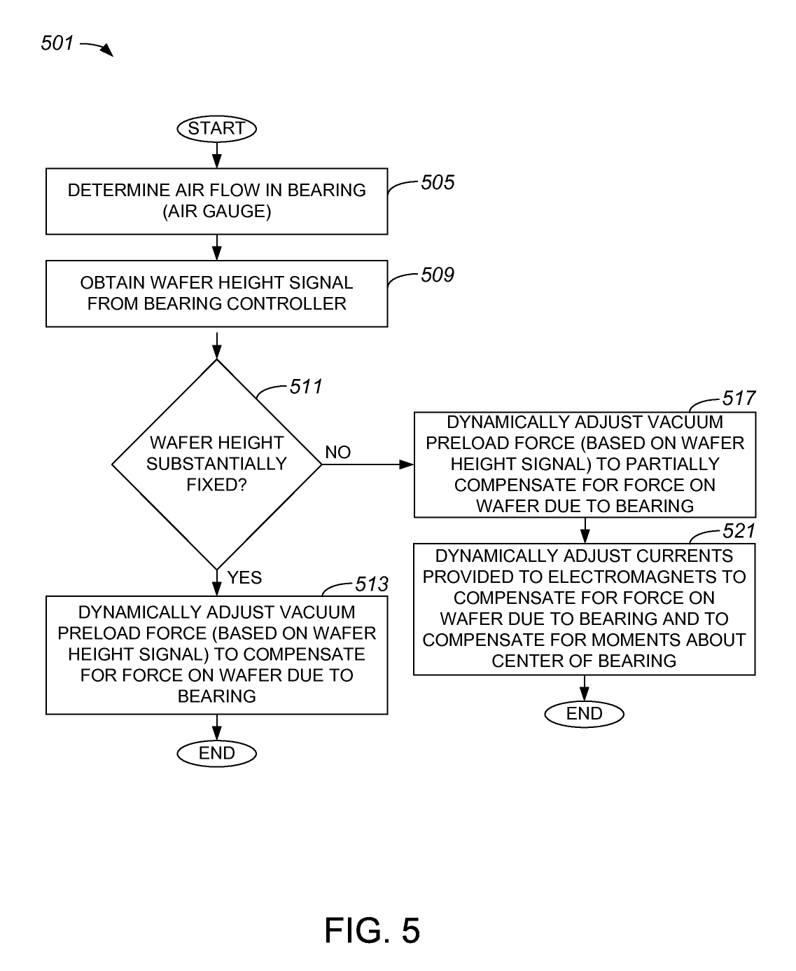

To compensate for bearing forces exerted on a wafer, a vacuum preload is applied. A vacuum preload may be provided by any suitable arrangement which may apply vacuum forces that substantially opposes bearing forces. FIG. 3 is a block diagram representation of an overall system which utilizes an air gauge arrangement, a controller, and a vacuum preload arrangement to efficiently measure the height of a photoresist-coated wafer surface in accordance with an embodiment of the present invention. An overall system 300 includes a wafer 308, an air gauge arrangement 304, a controller 306, and a vacuum preload arrangement 316. A measurement of air flow in air gauge arrangement 304 is monitored by controller 306 which sends a controlling signal to vacuum preload arrangement 316. Vacuum preload arrangement 316 is configured to apply a vacuum force to wafer 308. Hence, while air gauge arrangement 304 applies a bearing force to wafer 308, vacuum preload arrangement 316 applies a vacuum preload force on wafer 308 that opposes the bearing force, and effectively compensates for the bearing force. Generally, air gauge arrangement 304 may apply the bearing force to wafer 308 in one direction along a z-axis 318, and vacuum preload arrangement 316 may apply a vacuum preload force in an opposite direction along z-axis 318. As will be appreciated by those skilled in the art, a bearing force or load may be caused by an airflow associated with air gauge arrangement 304.

The amount of vacuum preload force that is provided by vacuum preload arrangement 316 may be dynamically adjusted. In one embodiment, the amount of vacuum preload force is dynamically adjusted based on a signal derived from a wafer height measurement. Hence, the vacuum preload force may substantially cancel the bearing force even in the presence of wafer height fluctuations.

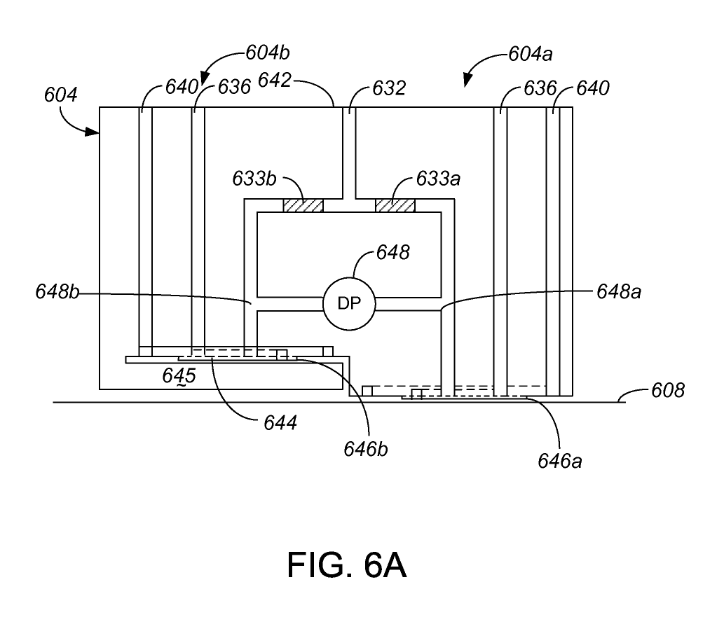

A vacuum preload force may be capable of compensating for a bearing force in some systems. In other systems, a vacuum preload force alone may not be sufficient to effectively compensate for the bearing force. For example, in addition to providing a vacuum preload force, a system may also utilize electromagnetic forces to maintain bearing force cancellation With reference to FIG. 4, an overall system which utilizes an air gauge arrangement, a vacuum preload arrangement, and electromagnetic forces to efficiently measure the height of a photoresist-coated wafer surface will be described in accordance with an embodiment of the present invention. An overall system, 400 includes a wafer 408 that is situated on a stage arrangement 420, in addition to an air gauge arrangement 404, a controller 406, and a vacuum preload arrangement 416. Air gauge arrangement 404 is effectively an air bearing arrangement. Vacuum preload arrangement 416 is arranged to generate a vacuum preload force that at least partially compensates for a bearing force or load exerted on wafer 408 by air gauge arrangement 404.

Air gauge arrangement 404 includes electromagnets 428 that are substantially mounted on a body associated with air gauge arrangement 404. Electromagnets 428 are configured to attract a ferromagnetic plate 424 installed on stage arrangement 420 to provide bearing force cancellation. A measurement of air flow in air gauge arrangement 404 is monitored by controller 406, which sends controlling signals to vacuum preload arrangement 416 and to electromagnets 428. Attractive forces between electromagnets 428 and ferromagnetic plate 424 and a vacuum preload force generated by vacuum preload arrangement 416 oppose a bearing force caused by air gauge arrangement 428. For example, attractive forces and a vacuum preload force may act in an opposite direction along a z-axis 418 than a bearing force.

As the height of a photoresist-coated surface of wafer 408 changes, currents in electromagnets 428 may be dynamically adjusted, as for example by controller 406, as necessary to maintain the cancellation of bearing forces exerted on wafer 408. Adjusting the currents provided to electromagnets 428 causes electromagnetic forces to be substantially adjusted. By adjusting currents provided to electromagnets 428, electromagnetic forces may be adjusted. In addition to adjusting electromagnetic forces to compensate for bearing forces, electromagnetic forces may be adjusted to compensate for substantially any moments about the center of air gauge arrangement 404. It should be appreciated that the amount of vacuum preload force may generally also be dynamically adjusted to maintain the cancellation of bearing forces.

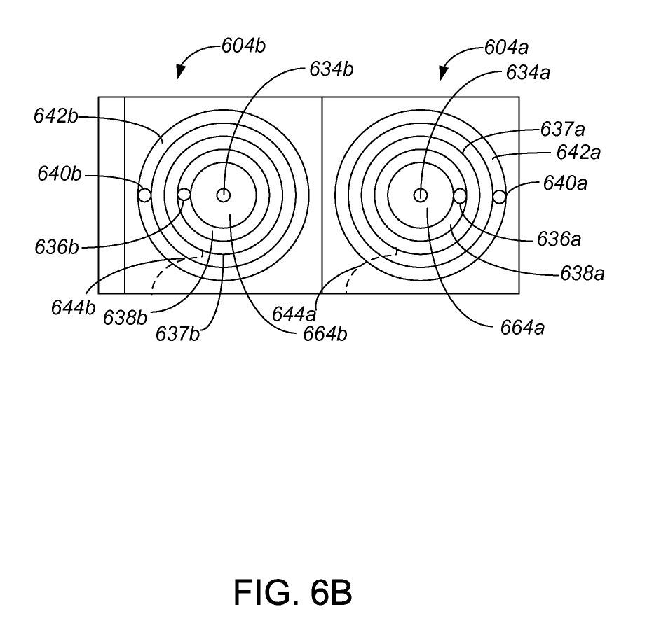

FIG. 5 is a process flow diagram which illustrates a process of operating a system which utilizes an air gauge to measure the height of a photoresist-coated wafer surface, and both a vacuum preload force and an electromagnetic force to compensate for forces applied by the air gauge arrangement, in accordance with an embodiment of the present invention. A process 501 of operating a system, which may be part of an autofocus system used in an overall photolithography apparatus, that measures the height of a photoresist-coated wafer surface begins at step 505 in which a bearing force, or a force or load exerted by an air bearing arrangement, on a wafer stage is determined. After the bearing force is determined, a wafer height signal is obtained from an air gauge in step 509. A determination is then made in step 511 as to whether the wafer height or, more specifically, a photoresist-coated surface of the wafer, is substantially fixed. In one embodiment, the wafer height may be considered to be substantially fixed when the wafer height is near a nominal height.

If the determination in step 511 is that the wafer height is substantially fixed, the compensation for the bearing force may be provided, in one embodiment, using substantially only a vacuum preload. In other words, when the wafer height deviates little from a nominal height, the vacuum preload force may be sufficient to compensate for, e.g., oppose, the bearing force or load. As such, in step 513, the vacuum preload force is dynamically adjusted, based on the wafer height signal, to compensate for the bearing force. Once the vacuum preload force is dynamically adjusted, the process of operating a system that measures the height of a photoresist-coated wafer surface is completed.

Alternatively, if the determination in step 511 is that the wafer height is not substantially fixed, the indication is that both a vacuum preload force and an electromagnetic force are to be used to compensate for a bearing force. In the described embodiment, the implication is that the wafer height is not substantially fixed. Accordingly, process flow moves from step 511 to step 517 in which the vacuum preload force is dynamically adjusted, based on the wafer height signal, to partially compensate for a bearing force. After the vacuum preload force is dynamically adjusted, the current provided to electromagnets is dynamically adjusted in step 521. The currents are dynamically adjusted to enable electromagnetic forces to compensate for a bearing force, and to compensate for moments about a center of an air bearing arrangement. Upon dynamically adjusting currents provided to electromagnets, the process of operating a system that measures the height of a photoresist-coated wafer surface is completed.

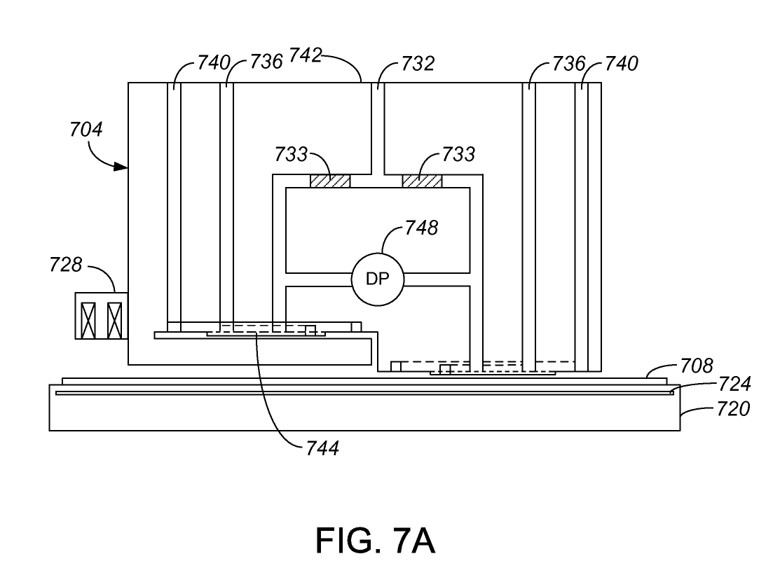

With reference to FIG. 6A and 6B, an air gauge or air bearing arrangement with a vacuum preload will be described in more detail in accordance with an embodiment of the present invention. FIG. 6A is a diagrammatic cross-sectional side-view representation of one embodiment of an air gauge arrangement. An overall air gauge arrangement 604 is arranged to be positioned over a top surface of a wafer 608, and has a surface 642 that is configured to interface with a metrology frame (not shown). Air gauge arrangement 604 includes a pressure supply groove 632 which is arranged to be coupled to an air supply (not shown) that provides pressurized air to air gauge arrangement 604.

As shown, flow restrictors 633 are arranged to restrict the flow of air via pressure supply passage 632. Flow restrictors 633 may isolate pressure measurements associated with a bearing differential pressure signal 648 from variations in an air supply pressure. The presence of flow restrictors 633 increases stiffness in air gauge arrangement 604. Flow restrictors 633 may be, but are not limited to being, orifices, capillary tubes, and/or porous plugs. As will be appreciated by those skilled in the art, capillary tubes and porous plugs are generally laminar flow restrictors.

An exhaust passage 636 is configured to exhaust air to an ambient environment. As shown, exhaust passage 636 may be positioned substantially between pressure supply passage 632 and vacuum supply passage 640.

A vacuum supply passage 640 is coupled to a vacuum supply (not shown) that supplies a vacuum through vacuum supply passage 640. The vacuum provides a vacuum preload force that opposes forces provided by pressurized air supplied through pressure supply passage 632.

Previous embodiments of the invention employ a measurement of the air flow through the air bearing to estimate the wafer height and the bearing load on the wafer. Such embodiments suffer from inaccuracies which occur when the supply pressure or the ambient pressure change by small relatively amounts. For example, changes in the supply pressure or the ambient pressure of approximately 1 Pa can affect the air flow through the air bearing and cause significant errors in the wafer height if not corrected. These errors can be limited to some extent by configuring the air gauge arrangement such that a wafer height change causes large changes in the air flow which exceed those caused by nominal changes in supply pressure or ambient pressure.

To avoid these types of errors, the embodiment shown in FIGS. 6A and 6B combines two air gauge arrangements 604a and 604b. Air gauge arrangement 604a forms an air bearing with wafer 608. The resulting air flow in the bearing creates an internal pressure 648a for a gap 646a separating the air gauge from the wafer. Air gauge arrangement 604b forms an air bearing with a plate 645 which is securely positioned at a fixed gap 646b from the air gauge arrangement 604b. The resulting air flow in the bearing creates an internal pressure 648b. Since the fixed gap 646b doesn't change, the pressure 648b does not change, except when system conditions change, such as caused by changes to the supply pressure or the ambient pressure. Since both supply pressure and ambient pressure are common to the two air gauge arrangements, it follows that the difference of the two pressure signals 648a, 648b, or a differential pressure 648, is typically not sensitive to such perturbations. Therefore, the differential pressure signal 648 represents a more stable and accurate signal for obtaining the wafer height than the signal 648a alone. Air gauge arrangement 604a is sometimes referred to as the measurement gauge, and air gauge arrangement 604b is sometimes referred to as the reference gauge. For maximum cancellation of common mode perturbations, the structures of air gauge arrangement 604a and air gauge arrangement 604b should be similar.

FIG. 6B shows a bottom view of the embodiment. A description is given for air gauge arrangement 604a. Pressurized air from air gauge emerges through exhaust 634a into bearing surface 664a. Bearing surface 664a is surrounded by exhaust groove 638a which conveys air from bearing surface 664a to exhaust passage 636a where it escapes to ambient. Surrounding exhaust groove 638a is a flat surface coplanar with the bearing surface 664a. The flat surface may extend to the outer surface of air arrangement 604a or it may end at a perimeter 637a, where the gap between the wafer surface and the air gauge surface is increased. A vacuum groove 642a surrounds the exhaust groove 638a and enables vacuum supply passage 640 and 640a to establish a relatively uniform partial vacuum region between approximately the perimeter 637a and the outer edge of air arrangement 604a. Such a geometry enables a vacuum preload to counter the bearing load without creating torques which could tend to tilt the wafer and/or air gauge assembly.

The bottom of air arrangement 604 is generally similar to the bottom of air gauge arrangement 604a for maximum cancellation of common mode perturbations. However, if the plate 645 which provides the gap 646b is sufficiently rigid, the bearing load of air gauge arrangement 604b may not significantly change the gap 646b. In that case a vacuum preload may not be necessary, and the related structures 637b, 640b, 642b and 644b may not be needed.

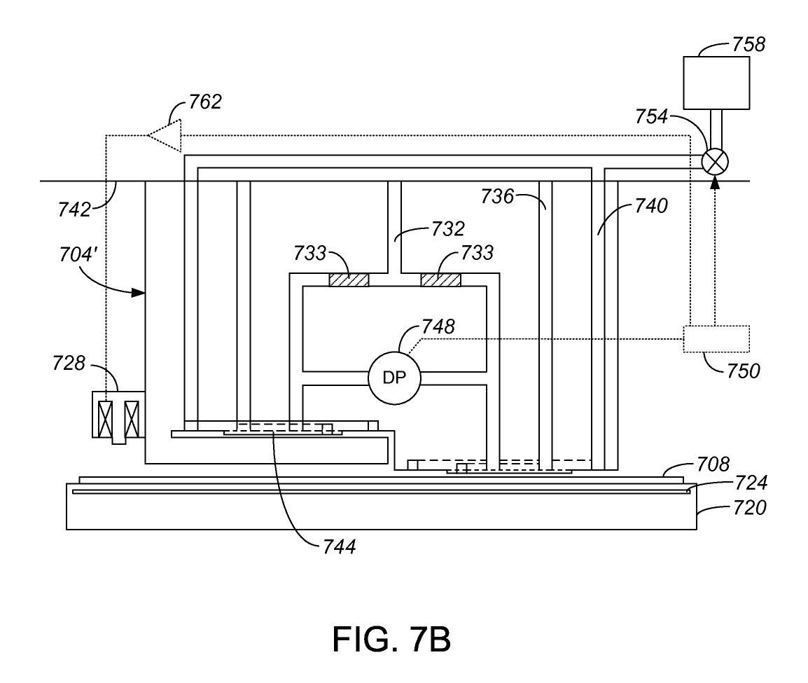

As previously mentioned, a bearing force or load exerted by an air gauge or air bearing arrangement may be compensated for by both a vacuum preload force and an electromagnetic force. FIG. 7A is a diagrammatic cross-sectional side-view representation of an air bearing arrangement with a vacuum preload and an electromagnet arrangement in accordance with an embodiment of the present invention. An overall air gauge arrangement 704 is arranged to be positioned over a top surface of a wafer 708, and has a surface 742 that is configured to interface with a metrology frame (not shown). Wafer 708 is positioned substantially on a wafer stage arrangement 720. Air gauge arrangement 704 includes a pressure supply passage 732, a vacuum supply passage 740, and an exhaust passage 736.

Optional flow restrictors 733 are arranged to restrict the flow of air via pressure supply passage 732. Flow restrictors 733, when present, are configured to substantially isolate pressure measurements associated with a bearing differential pressure signal DP 748 from variations in an air supply pressure.

Bearing differential pressure signal DP 748 may be used to adjust the amount of vacuum provided through vacuum supply passage 740. In addition, bearing differential pressure signal DP 748 may also be used to adjust electromagnetic forces provided by an electromagnet arrangement 728. As will be appreciated by those skilled in the art, attractive forces may exist between electromagnet arrangement 728 and a ferromagnetic plate 724 installed in stage arrangement 720. Such attractive forces, i.e., electromagnetic forces, may be dynamically altered by altering the amount of current provided to electromagnet arrangement 728.

Ferromagnetic plate 724 will add weight to stage arrangement 720 and, thus, ferromagnetic plate 724 is preferably as thin as possible. However, as the magnetic flux flowing through ferromagnetic plate 724 is to be substantially prevented from changing the properties of a magnetic circuit formed between electromagnet arrangement 728 and ferromagnetic plate 724, the thickness of ferromagnetic plate 724 is chosen to prevent the magnetic flux from essentially saturating ferromagnetic plate 724 In general, the thickness of ferromagnetic plate 724 may vary widely based on a variety of different factors including, but not limited to including, the maximum magnetic field in a gap between air gauge arrangement 704 and wafer 708, a saturation point associated with ferromagnetic plate 724, and/or a maximum force from electromagnet arrangement 728. For example, for a maximum magnetic field in the gap between air gauge arrangement 704 and wafer 708 is approximately 0.1 Tesla (T), and ferromagnetic plate 724 saturates at approximately 1 T, then the thickness of ferromagnetic plate 724 may be approximately 0.5 millimeters (mm). If ferromagnetic plate 724 is approximately 0.5 mm thick, and wafer 708 has a diameter of approximately 450 mm, then the mass of ferromagnetic plate 724 may be approximately 0.6 kilograms if ferromagnetic plate 724 is formed from steel. It should be understood that ferromagnetic plate 724 may be formed from materials other than steel. Other materials may include, but are not limited to including, invar.

As the height of a photoresist-coated surface of wafer 708 changes, the amount of current provided to electromagnet arrangement 728 may be adjusted by bearing differential pressure signal DP 748 to maintain force cancellation. More specifically, the amount of current provided to electromagnet arrangement 728 as well as the amount of vacuum preload force provided through vacuum supply passage 740 may be dynamically adjusted as necessary based on bearing differential pressure signal DP 748 such that the bearing force exerted by air gauge arrangement 704 on wafer 708 may be substantially cancelled. The amount of current provided to electromagnet arrangement 728 may also be adjusted to substantially cancel moments about a center of air gauge arrangement 704.

In general, air gauge arrangement 704 may be coupled to at least one controller that provides circuitry and/or logic which allows vacuum preload forces and electromagnetic forces to be substantially adjusted based on the height of a photoresist-coated surface of wafer 708. FIG. 7B is a diagrammatic representation of an air bearing arrangement with a vacuum preload and an electromagnet arrangement, e.g., air gauge or bearing arrangement 704 of FIG. 7A, as shown with a control system in accordance with an embodiment of the present invention. An air gauge arrangement 704′ includes a controller 750 which obtains bearing differential pressure signal DP 748, and processes bearing differential pressure signal DP 728 such that an amount of vacuum provided from a vacuum supply 758, or a partial vacuum supply, to vacuum supply passage 740 may be controlled through a valve 754. Controller 750 also processes bearing differential pressure signal DP 728 such that a current provided to electromagnet arrangement 728 may be controlled by amplifier current supply 762.

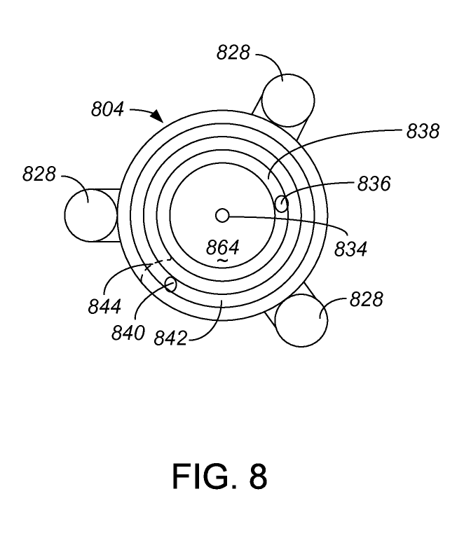

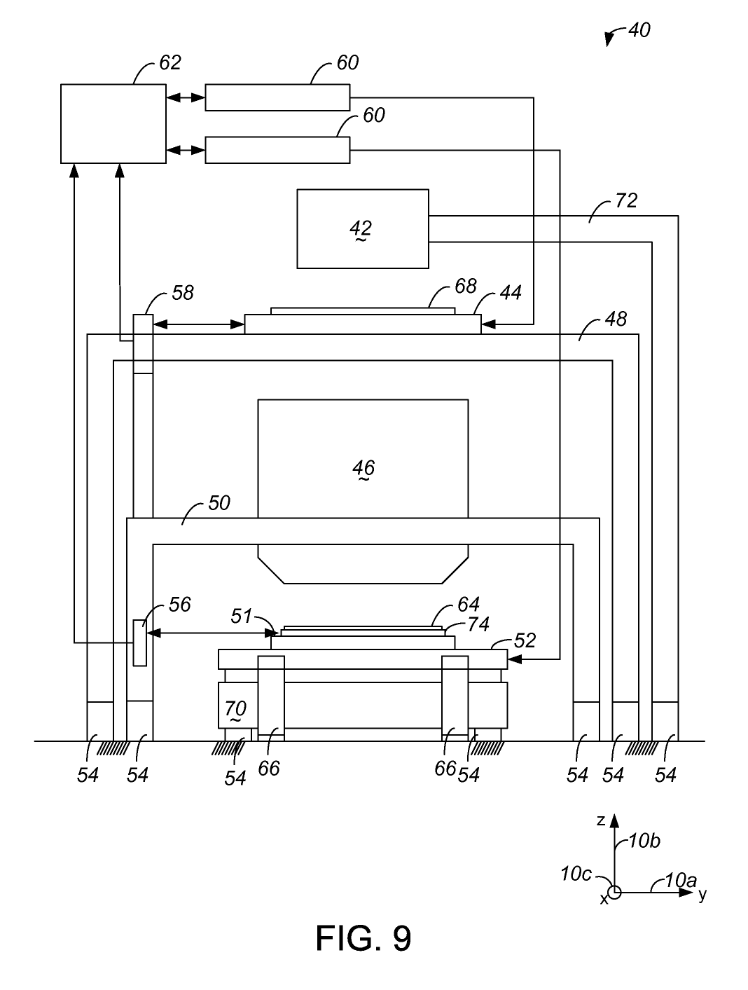

FIG. 8 is a diagrammatic bottom-view representation of an air bearing arrangement which includes electromagnets in accordance with an embodiment of the present invention. An air gauge or bearing arrangement 804 generally includes a bearing surface 864, an exhaust pressure supply passage 832, an exhaust passage 836 and an exhaust groove 838, and a vacuum supply passage 840 and a vacuum groove 842 which assists the distribution of vacuum to a region 844. A plurality of electromagnet arrangements 828, which may each include one or more electromagnets (not shown), are positioned substantially on an exterior surface of air gauge arrangement 804. As shown, vacuum supply passage 840, which supplies a vacuum preload region 844, substantially surrounds the perimeter of bearing surface 864. Hence, a bearing force or load is applied by bearing surface 864 in a first region on a wafer (not shown), and a vacuum preload force is applied by vacuum supply passage 840 in a second region of the wafer that substantially surrounds the perimeter of the first region. With reference to FIG. 9, a photolithography apparatus which may include an air gauge configured to be sensitive to a wafer height will be described in accordance with an embodiment of the present invention. A photolithography apparatus (exposure apparatus) 40 includes a wafer positioning stage 52 that may be driven by a planar motor (not shown), as well as a wafer table 51 that is magnetically coupled to wafer positioning stage 52 by utilizing an ELI-core actuator. The planar motor which drives wafer positioning stage 52 generally uses an electromagnetic force generated by magnets and corresponding armature coils arranged in two dimensions.

A wafer 64 is held in place on a wafer holder or chuck 74 which is coupled to wafer table 51. Wafer positioning stage 52 is arranged to move in multiple degrees of freedom, e.g., in up to six degrees of freedom, under the control of a control unit 60 and a system controller 62. In one embodiment, wafer positioning stage 52 may include a plurality of actuators and have a configuration as described above. The movement of wafer positioning stage 52 allows wafer 64 to be positioned at a desired position and orientation relative to a projection optical system 46.

Wafer table 51 may be levitated in a z-direction lob by any number of voice coil motors (not shown), e.g., three voice coil motors. In one described embodiment, at least three magnetic bearings (not shown) couple and move wafer table 51 along a y-axis lea. The motor array of wafer positioning stage 52 is typically supported by a base 70. Base 70 is supported to a ground via isolators 54. Reaction forces generated by motion of wafer stage 52 may be mechanically released to a ground surface through a frame 66. One suitable frame 66 is described in JP Heir 8-166475 and U.S. Pat. No. 5,528,118, which are each herein incorporated by reference in their entireties.

An illumination system 42 is supported by a frame 72. Frame 72 is supported to the ground via isolators 54. Illumination system 42 includes an illumination source, which may provide a beam of light that may be reflected off of a reticule. In one embodiment, illumination system 42 may be arranged to project a radiant energy, e.g., light, through a mask pattern on a reticule 68 that is supported by and scanned using a reticule stage 44 which may include a coarse stage and a fine stage, or which may be a single, monolithic stage. The radiant energy is focused through projection optical system 46, which is supported on a projection optics frame 50 and may be supported the ground through isolators 54. Suitable isolators 54 include those described in JP Hei 8-330224 and U.S. Pat. No. 5,874,820, which are each incorporated herein by reference in their entireties.

A first interferometer 56 is supported on projection optics frame 50, and functions to detect the position of wafer table 51. Interferometer 56 outputs information on the position of wafer table 51 to system controller 62. In one embodiment, wafer table 51 has a force damper which reduces vibrations associated with wafer table 51 such that interferometer 56 may accurately detect the position of wafer table 51. A second interferometer 58 is supported on projection optical system 46, and detects the position of reticle stage 44 which supports a reticle 68. Interferometer 58 also outputs position information to system controller 62.

It should be appreciated that there are a number of different types of photolithographic apparatuses or devices. For example, photolithography apparatus 40, or an exposure apparatus, may be used as a scanning type photolithography system which exposes the pattern from reticle 68 onto wafer 64 with reticle 68 and wafer 64 moving substantially synchronously. In a scanning type lithographic device, reticle 68 is moved perpendicularly with respect to an optical axis of a lens assembly (projection optical system 46) or illumination system 42 by reticle stage 44. Wafer 64 is moved perpendicularly to the optical axis of projection optical system 46 by a wafer stage 52. Scanning of reticle 68 and wafer 64 generally occurs while reticle 68 and wafer 64 are moving substantially synchronously.

Alternatively, photolithography apparatus or exposure apparatus 40 may be a step-and-repeat type photolithography system that exposes reticle 68 while reticle 68 and wafer 64 are stationary, i.e., at a substantially constant velocity of approximately zero meters per second. In one step and repeat process, wafer 64 is in a substantially constant position relative to reticle 68 and projection optical system 46 during the exposure of an individual field. Subsequently, between consecutive exposure steps, wafer 64 is consecutively moved by wafer positioning stage 52 perpendicularly to the optical axis of projection optical system 46 and reticle 68 for exposure. Following this process, the images on reticle 68 may be sequentially exposed onto the fields of wafer 64 so that the next field of semiconductor wafer 64 is brought into position relative to illumination system 42, reticle 68, and projection optical system 46.

It should be understood that the use of photolithography apparatus or exposure apparatus 40, as described above, is not limited to being used in a photolithography system for semiconductor manufacturing. For example, photolithography apparatus 40 may be used as a part of a liquid crystal display (LCD) photolithography system that exposes an LCD device pattern onto a rectangular glass plate or a photolithography system for manufacturing a thin film magnetic head.

The illumination source of illumination system 42 may be g-line (436 nanometers (nm)), i-line (365 nm), a KrF excimer laser (248 nm), an ArF excimer laser (193 nm), and an F2-type laser (157 nm). Alternatively, illumination system 42 may also use charged particle beams such as x-ray and electron beams. For instance, in the case where an electron beam is used, thermionic emission type lanthanum hexaboride (LaB6) or tantalum (Ta) may be used as an electron gun. Furthermore, in the case where an electron beam is used, the structure may be such that either a mask is used or a pattern may be directly formed on a substrate without the use of a mask.

With respect to projection optical system 46, when far ultra-violet rays such as an excimer laser are used, glass materials such as quartz and fluorite that transmit far ultra-violet rays is preferably used. When either an F2-type laser or an x-ray is used, projection optical system 46 may be either catadioptric or refractive (a reticle may be of a corresponding reflective type), and when an electron beam is used, electron optics may comprise electron lenses and deflectors. As will be appreciated by those skilled in the art, the optical path for the electron beams is generally in a vacuum.

In addition, with an exposure device that employs vacuum ultra-violet (VUV) radiation of a wavelength that is approximately 200 nm or lower, use of a catadioptric type optical system may be considered. Examples of a catadioptric type of optical system include, but are not limited to, those described in Japan Patent Application Disclosure No. 8-171054 published in the Official gazette for Laid-Open Patent Applications and its counterpart U.S. Pat. No. 5,668,672, as well as in Japan Patent Application Disclosure No. 10-20195 and its counterpart U.S. Pat. No. 5,835,275, which are all incorporated herein by reference in their entireties. In these examples, the reflecting optical device may be a catadioptric optical system incorporating a beam splitter and a concave mirror. Japan Patent Application Disclosure (Hei) No. 8-334695 published in the Official gazette for Laid-Open Patent Applications and its counterpart U.S. Pat. No. 5,689,377, as well as Japan Patent Application Disclosure No. 10-3039 and its counterpart U.S. Pat. No. 5,892,117, which are all incorporated herein by reference in their entireties. These examples describe a reflecting-refracting type of optical system that incorporates a concave mirror, but without a beam splitter, and may also be suitable for use with the present invention.

The present invention may be utilized, in one embodiment, in an immersion type exposure apparatus if suitable measures are taken to accommodate a fluid. For example, PCT patent application WO 99/49504, which is incorporated herein by reference in its entirety, describes an exposure apparatus in which a liquid is supplied to a space between a substrate (wafer) and a projection lens system during an exposure process. Aspects of PCT patent application WO 99/49504 may be used to accommodate fluid relative to the present invention.

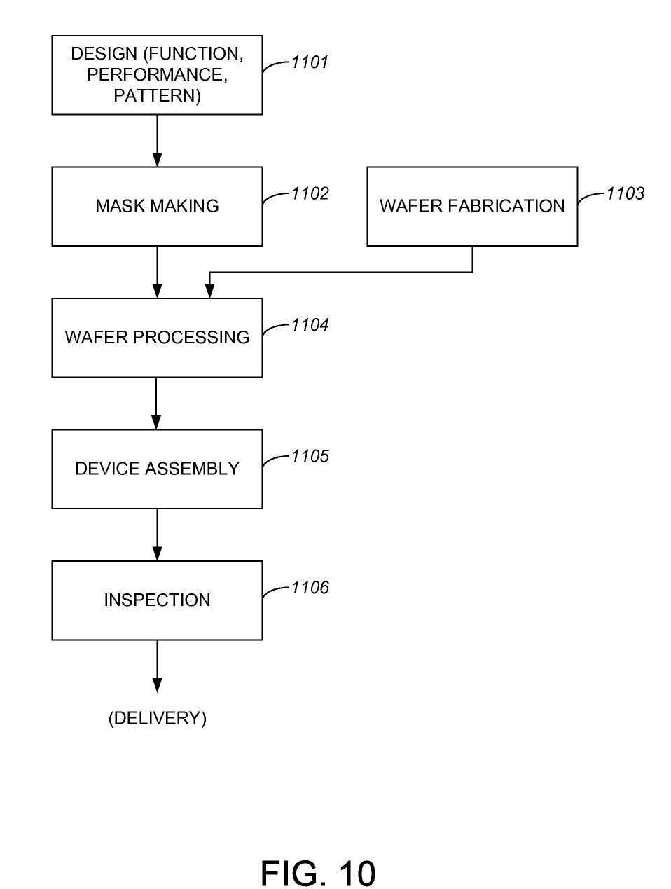

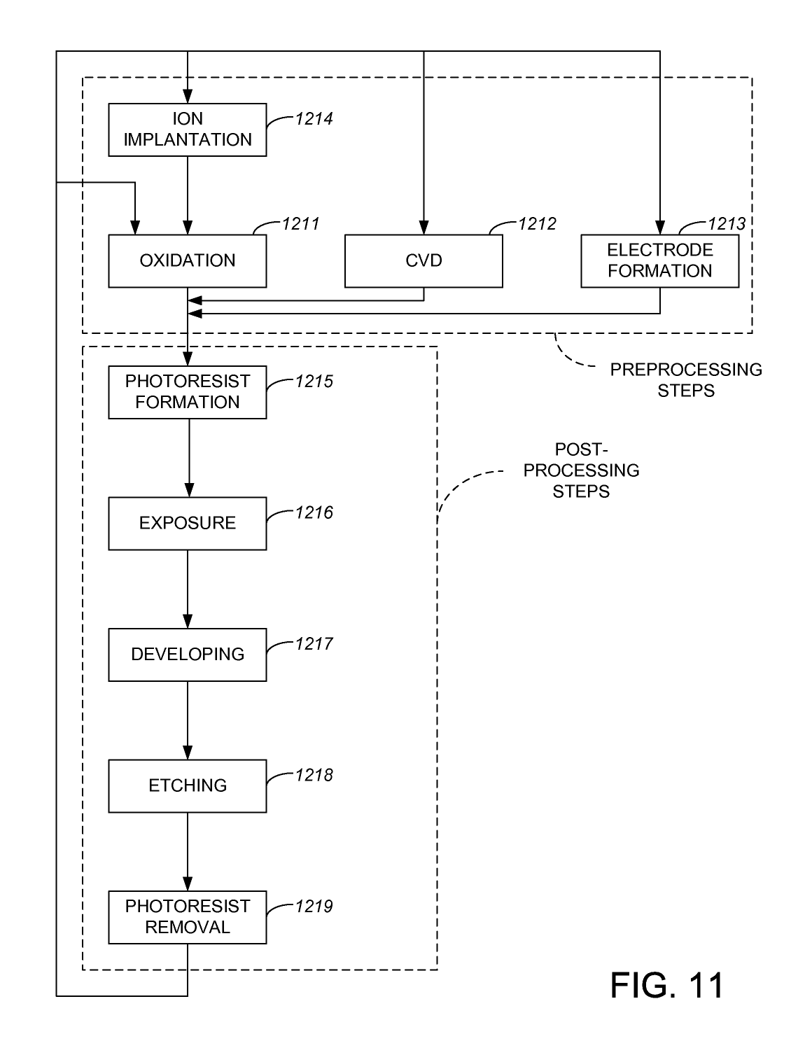

Further, semiconductor devices may be fabricated using systems described above, as will be discussed with reference to FIG. 10. FIG. 10 is a process flow diagram which illustrates the steps associated with fabricating a semiconductor device in accordance with an embodiment of the present invention. A process 1001 of fabricating a semiconductor device begins at step 1003 in which the function and performance characteristics of a semiconductor device are designed or otherwise determined. Next, in step 1005, a reticle or mask in which has a pattern is designed based upon the design of the semiconductor device. It should be appreciated that in a substantially parallel step 1009, a wafer is typically made from a silicon material. In step 1013, the mask pattern designed in step 1005 is exposed onto the wafer fabricated in step 1009. One process of exposing a mask pattern onto a wafer will be described below with respect to FIG. 11. In step 1017, the semiconductor device is assembled. The assembly of the semiconductor device generally includes, but is not limited to including, wafer dicing processes, bonding processes, and packaging processes. Finally, the completed device is inspected in step 1021. Upon successful completion of the inspection in step 1021, the completed device may be considered to be ready for delivery.

FIG. 11 is a process flow diagram which illustrates the steps associated with wafer processing in the case of fabricating semiconductor devices in accordance with an embodiment of the present invention. In step 1101, the surface of a wafer is oxidized. Then, in step 1105 which is a chemical vapor deposition (CVD) step in one embodiment, an insulation film may be formed on the wafer surface. Once the insulation film is formed, then in step 1109, electrodes are formed on the wafer by vapor deposition. Then, ions may be implanted in the wafer using substantially any suitable method in step 1113. As will be appreciated by those skilled in the art, steps 1101-1113 are generally considered to be preprocessing steps for wafers during wafer processing. Further, it should be understood that selections made in each step, e.g., the concentration of various chemicals to use in forming an insulation film in step 1105, may be made based upon processing requirements.

At each stage of wafer processing, when preprocessing steps have been completed, post-processing steps may be implemented. During post-processing, initially, in step 1117, photoresist is applied to a wafer. Then, in step 1121, an exposure device may be used to transfer the circuit pattern of a reticle to a wafer. Transferring the circuit pattern of the reticle of the wafer generally includes scanning a reticle scanning stage which may, in one embodiment, include a force damper to dampen vibrations.

After the circuit pattern on a reticle is transferred to a wafer, the exposed wafer is developed in step 1125. Once the exposed wafer is developed, parts other than residual photoresist, e.g., the exposed material surface, may be removed by etching in step 1129. Finally, in step 1133, any unnecessary photoresist that remains after etching may be removed. As will be appreciated by those skilled in the art, multiple circuit patterns may be formed through the repetition of the preprocessing and post-processing steps.

Although only a few embodiments of the present invention have been described, it should be understood that the present invention may be embodied in many other specific forms without departing from the spirit or the scope of the present invention. By way of example, although electromagnets have been described as being used in conjunction with a vacuum preload to compensate for a bearing force, electromagnets may be used without a vacuum preload to compensate for a bearing force. In other words, electromagnetic forces alone may be used to compensate for a bearing force exerted on a wafer.

An air gauge arrangement has been described as being suitable for measuring a height of a photoresist-coated top surface of a wafer. However, an air gauge arrangement is not limited to measuring a height of a photoresist-coated top surface of a wafer. An air gauge arrangement which includes a vacuum preload as described above may be used to measure substantially any height.

In one embodiment, when electromagnets are used, shielding may be included within an overall system. Shielding may, for example, prevent the electromagnets from having an adverse effect on components which are sensitive to, and may interact with, the electromagnets.

A wafer may move upwards and downwards in some systems. In such systems, a servo motor may be used to move a wafer stage on which the wafer is positioned, or to move an air gauge or bearing arrangement, such that the distance between the wafer stage and the air gauge arrangement may remain substantially unchanged. When a servo motor is used, either an open-loop or closed-loop servo controller may be used to control the servo motor. In one embodiment, a signal from the air gauge arrangement may be provided to the servo controller.

The amount of bearing forces or load exerted on a wafer may vary widely. For example, the supply pressure of air supplied to an air gauge or bearing arrangement may be reduced such that bearing forces may be kept below approximately ten milliNewtons (mN). In the event that there are higher bearing forces, an increased vacuum preload which substantially surrounds the perimeter of the bearing, e.g., as shown in FIG. 8, may substantially cancel out the higher bearing forces.

The embodiments of the present invention may be implemented as hardware and/or software logic embodied in a tangible medium that, when executed, is operable to perform the various methods and processes described above. That is, the logic may be embodied as physical arrangements or components, or as software logic. For example, derivative controllers that derive or otherwise construct velocities and accelerations based on position measurements may be implemented as include hardware logic, software logic, or a combination of both hardware and software logic. The tangible medium may be substantially any computer-readable medium that is capable of storing logic which may be executed, e.g., by a computing system, to perform methods and functions associated with the embodiments of the present invention.

The operations associated with the various methods of the present invention may vary widely. By way of example, steps may be added, removed, altered, combined, and reordered without departing from the spirit or the scope of the present invention.

The many features of the present invention are apparent from the written description. Further, since numerous modifications and changes will readily occur to those skilled in the art, the invention should not be limited to the exact construction and operation as illustrated and described. Hence, all suitable modifications and equivalents may be resorted to as falling within the scope of the invention.

What is claimed is:

1. A method for measuring a height associated with a wafer, the method comprising:
determining a first magnitude of a bearing load exerted on the wafer, the bearing load being exerted by an arrangement configured to determine the height associated with the wafer, wherein the bearing load is exerted on the wafer in a first direction; and
compensating for the bearing load, wherein compensating for the bearing load includes applying an opposing force to the wafer, the opposing force including at least a vacuum preload force, the vacuum preload force being applied in a second direction that is opposite from the first direction, the opposing force being calculated to have a second magnitude that is approximately equal to the first magnitude.

2. The method of claim 1 wherein the bearing load is applied to a first region on the wafer, the first region having a perimeter, and wherein the vacuum preload force is applied on a second region of the wafer, the second region being arranged to substantially surround the perimeter.

3. The method of claim 1 wherein the arrangement configured to determine the height associated with the wafer includes an air gauge and an air supply arrangement, the air gauge being configured to determine the height associated with the wafer, the air supply arrangement being arranged to exert the bearing load on the wafer.

4. The method of claim 1 wherein opposing force further includes an electromagnetic force, the electromagnetic force being applied in the second direction.

5. The method of claim 4 wherein the vacuum preload force is arranged to have a third magnitude that is approximately equal to the first magnitude when the height is near approximately equal to a nominal height.

6. The method of claim 4 wherein the opposing force further includes the electromagnetic force when the height is not approximately equal to a nominal height.

7. The method of claim 5 wherein the electromagnetic force is associated with an attractive force between an electromagnet arrangement and a ferromagnetic plate.

8. The method of claim 1 further including obtaining a bearing pressure signal, wherein compensating for the bearing load includes dynamically adjusting the opposing force based on the bearing pressure signal.

9. An apparatus comprising:
a stage arrangement, the stage arrangement being arranged to support a wafer, the wafer having a first height;
an air bearing arrangement, the air bearing arrangement including an air gauge configured to measure the first height, the air bearing arrangement being arranged to provide a bearing pressure signal, wherein the air bearing arrangement exerts a bearing force in a first direction on a first region of the wafer, the bearing force having a first magnitude; and
a vacuum supply arrangement, the vacuum supply arrangement being arranged to apply a vacuum preload force that opposes the bearing force, the vacuum preload force being arranged to be applied on a second region of the wafer, the second region of the wafer being substantially around a perimeter of the first region of the wafer, wherein the vacuum preload force is dynamically adjusted based on the bearing pressure signal.

10. The apparatus of claim 9 wherein the stage arrangement includes a ferromagnetic plate, the apparatus further including:
an electromagnet arrangement, the electromagnet arrangement including at least one electromagnet that cooperates with the ferromagnetic plate to provide an electromagnetic force that cooperates with the vacuum preload force to oppose the bearing force, the electromagnetic force and the vacuum preload force having a second magnitude that is approximately equal to the first magnitude, wherein the electromagnetic force is dynamically adjusted based on the bearing pressure signal.

11. The apparatus of claim 10 wherein the electromagnetic force is dynamically adjusted by adjusting an amount of current provided to the electromagnet arrangement based on the bearing pressure signal.

12. The apparatus of claim 10 wherein the electromagnetic force is further dynamically adjusted to compensate for at least one moment about a center of the air bearing arrangement.

13. The apparatus of claim 10 wherein if the first height is approximately equal to a nominal height, the vacuum preload force has the second magnitude.

14. The apparatus of claim 9 wherein the vacuum supply arrangement includes a vacuum supply passage arranged substantially around the air bearing arrangement.

15. The apparatus of claim 9 wherein the air bearing arrangement includes an air supply arrangement, the air supply arrangement being arranged to provide pressurized air that causes the bearing force to be exerted on the first region of the wafer.

16. The apparatus of claim 9 wherein the vacuum preload force that opposes the bearing force is provided in a second direction, the second direction being opposite from the first direction.

17. The apparatus of claim 9 wherein the first height is a height of a photoresist-coated layer of the wafer.

18. An autofocus system comprising the apparatus of claim 9.

19. An exposure apparatus comprising the autofocus system of claim 19.

20. A wafer formed using the exposure apparatus of claim 19.

20. An apparatus comprising:
an air bearing arrangement, the air bearing arrangement including an air supply arrangement and an air gauge, the air supply arrangement being arranged to exert a bearing force of a first magnitude in a first direction on a wafer, the air gauge being arranged to measure a height of a photoresist-coated surface of the wafer, wherein the air bearing arrangement is configured to produce a bearing pressure signal;
a vacuum preload arrangement, the vacuum preload arrangement being configured to provide a vacuum preload force on the wafer that opposes the bearing force, wherein a second magnitude of the vacuum preload force is determined using the bearing pressure signal; and
an electromagnet arrangement, the electromagnet arrangement including at least one electromagnet, the electromagnet arrangement being configured to provide an electromagnetic force that cooperates with the vacuum preload force to oppose the bearing force, wherein a third magnitude of the electromagnetic force is determined using the bearing pressure signal.

21. The apparatus of claim 20 further including:
a stage arrangement, the stage arrangement being arranged to hold the wafer, the stage arrangement including a ferromagnetic plate that cooperates with the at least one electromagnet to provide the electromagnetic force

22. The apparatus of claim 20 wherein when the height is approximately equal to a nominal height, the second magnitude is approximately equal to the first magnitude, and the electromagnet arrangement does not provide the electromagnetic force.

23. The apparatus of claim 22 wherein when the height is not approximately equal to the nominal height, the second magnitude and the third magnitude sum together to approximately equal the first magnitude.

24. The apparatus of claim 20 wherein the vacuum preload force and the electromagnetic force are dynamically adjusted based on the bearing pressure signal.

25. An autofocus system comprising the apparatus of claim 20.

26. An exposure apparatus comprising the autofocus system of claim 25.

27. A wafer formed using the exposure apparatus of claim 26.
